(19) United States
(12) Patent Application Publication
(10) Pub. No.: US 2009/0260900 A1
(43) Pub. Date: Oct. 22, 2009

(54) Untethered electrostatic pen/stylus for use with capacitive touch sensor

(76) Inventor: Michael J. Ure, Cupertino, CA (US)

Correspondence Address: MICHAEL J. URE, 10518 PHIL PLACE, CUPERTINO, CA, 95014, US

(21) Appl. No.: 12/104,392

(22) Filed: Apr. 16, 2008

(51) Int. Cl. G06F 3/041

(52) U.S. Cl. 178/19.03

(57) ABSTRACT

An untethered electrostatic pen/stylus for use with capacitive touch sensors, described herein, allows for a single device like the iPhone to receive input via both finger touches and a stylus. Stylus input is more precise for various uses including, for example, text input and drawing input.

The well-known Apple iPhone™ cellphone has a capacitive touch-screen interface designed to respond to finger touches but not to stylus input using, for example, a plastic stylus or the like. The Apple Newton™ personal digital assistant, on the other hand, had a pressure-sensitive touch-screen interface designed to respond to stylus input using a plastic stylus but not to finger touches.

An untethered electrostatic pen/stylus for use with capacitive touch sensors, described herein, allows for a single device like the iPhone to receive input via both linger touches and a stylus. Stylus input is more precise for various uses including, for example, text input and drawing input.

Other features and advantages will be understood upon reading and understanding the detailed description of exemplary embodiments, found herein below, in conjunction with reference to the drawings, a brief description of which is provided below.

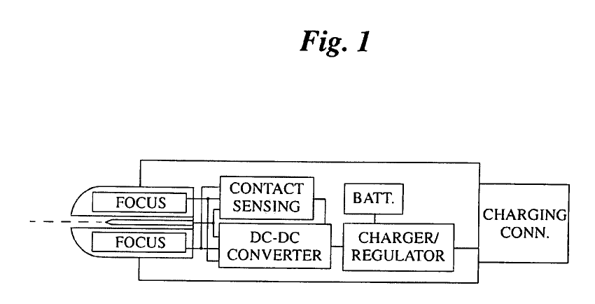

FIG. 1 is a diagram of an untethered electrostatic pen or stylus.

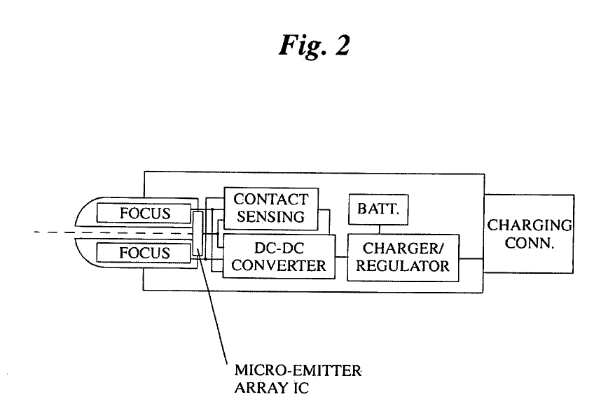

FIG. 2 is a diagram of another untethered electrostatic pen or stylus.

There follows a more detailed description of the present invention. Those skilled in the art will realize that the following detailed description is illustrative only and is not intended to be in any way limiting. Other embodiments of the present invention will readily suggest themselves to such skilled persons having the benefit of this disclosure. Reference will now be made in detail to embodiments of the present invention as illustrated in the accompanying drawings. The same reference indicators will be used throughout the drawings and the following detailed description to refer to the same or like parts.

Referring now to FIG. 1, a diagram is shown of an untethered electrostatic pen/stylus for use with capacitive touch sensors. A sharp-tipped field-emission electrode is connected to a high voltage, (e.g., 100-1000V or more) produced by a DC-DC converter of a known type (for example, a Q Series ultra-miniature DC to HV DC converter available from EMCO High Voltage Corporation of Sutter Creek, Calif.). The DC-DC converter is supplied with power from a battery by a charger/regulator block. The charger/regulator block is connected to a charging connection mounted so as to be accessible from outside a housing. Application of a high voltage to the field-emission electrode causes an electron beam to be emitted. Adjacent to and possible surrounding the field-emission electrode is one or more electron beam focusing elements forming an electron beam lens. Various types of electron beam lens, such as the Einzel electron beam lens, are known in the art.

Also provided is a contact sensor. The function of the contact sensor is to sense when a tip of the untethered electrostatic pen/stylus has been brought into contact with or removed from contact with a surface, i.e., the surface of a capacitive touch sensor. During contact, the high voltage is applied to the field-emission electrode. During the absence of such contact, the high voltage is not applied to the field-emission electrode. The contact sensor may take any of various forms, including for example a microswitch, an optoelectronic switch, an oscillator and counter, an acoustic impedance sensor, etc.

In one embodiment, the untethered electrostatic pen/stylus may take a similar form as a USB drive, with the charging connector being a USB connector. The untethered electrostatic pen/stylus may therefore be easily charged from a PC or other line powered or battery powered electronic device. A snap-on cap may be provided that covers the field-emission electrode and surrounding structure.

Referring to FIG. 2, another embodiment of a untethered electrostatic pen/stylus is shown. In this embodiment, the field-emission electrode is replaced by an integrated circuit having formed thereon a field-emission array having hundreds, thousands, or even lens of thousands of individual micro-emitters. The micro-emitters may be formed within a vacuum envelope and emit through a sealed “window” that is relatively transparent to electron emission (e.g., a layer of silicon a few microns thick) as described for example in U.S. Pat. No. 6,714,625 entitled Lithography Device for Semiconductor Circuit Pattern Generation, issued Mar. 30, 2004, incorporated herein by reference.

The untethered electrostatic pen or stylus may incorporate the features of a USB drive or other similar devices.

Although embodiments of the present invention have been described in detail, it should be understood that various changes, substitutions and alternations can be made without departing from the spirit and scope of the inventions as defined by the appended claims.

What is claimed is:

1. A pen or stylus for interacting with a capacitive touch sensor, comprising:
an elongated housing having a grip area to be gripped in a writing grip; and
an electron beam source within the elongated housing.

2. The apparatus of claim 1, wherein the electron beam source comprises a field-emission electrode.

3. The apparatus of claim 2, wherein the electron beam source comprises a field-emission array of micro-emitters.

4. The apparatus of claim 1, comprising an electron beam lens for focusing an electron beam produced by the electron beam source.

5. The apparatus of claim 1, comprising a rechargeable battery and a charging connector.

6. The apparatus of claim 1, wherein the charging connector is a USB connector.

7. The apparatus of claim 1, comprising a contact switch responsive to contact of the pen/stylus for causing supply of a high voltage to the electron beam source to be interrupted during absence of contact.
